(19) United States
(12) Patent Application Publication
(10) Pub. No.: US 2023/0395068 A1
(43) Pub. Date: Dec. 7, 2023

(54) NOISE MODELING FOR IMPROVING SPEECH RECOGNITION SYSTEMS

(71) Applicant: VIETTEL GROUP, Ha Noi City (VN)

(72) Inventors: Van Hai Do, Ha Noi City (VN); Nhat Minh Le, Ha Noi City (VN); Tung Lam Nguyen, Ha Noi City (VN); Tien Thanh Nguyen, Tien Du District (VN); Dang Linh Le, Ha Noi City (VN); Dinh Son Dang, Ha Noi City (VN); Thi Ngoc Anh Nguyen, Vinh City (VN); Minh Khang Pham, Ha Noi City (VN); Bao Thang Ta, Gia Binh District (VN); Quang Tien Duong, Hai Phong City (VN); Ngoc Dung Nguyen, Ha Noi City (VN); Manh Quan Tran, Ha Noi City (VN); Manh Quy Nguyen, Ha Noi City (VN)

(73) Assignee: VIETTEL GROUP, Ha Noi City (VN)

(21) Appl. No.: 18/132,258

(22) Filed: Apr. 7, 2023

(30) Foreign Application Priority Data
Jun. 7, 2022 (VN) 1-2022-03579

(51) Int. Cl. G10L 15/20; G10L 15/06

(52) U.S. Cl. CPC G10L 15/20; G10L 15/063

(57) ABSTRACT

The present invention provides a noise modeling method to improve the speech recognition quality to help the recognition system perform better in real-life environments. With this method, we not only add noise to the training audio signal to simulate different environments, but we also add noise labels to the speech transcripts. Since then, the recognition model will perform better in different environments and increase the accuracy of the recognition model.

### BACKGROUND

### 1. Technical Field

The invention relates to a method of noise modeling to enhance speech recognition quality. Specifically, the present invention relates to a method to enhance speech recognition quality in different real-life environments.

### 2. Introduction

In practice, speech recognition systems often operate in environments with various noises such as office noise, street noise, music noise, etc. However, the recognition systems are usually trained from data recorded in little or no noise environments. This leads to degraded recognition quality under actual operating conditions. To overcome this problem, we can add noise to the training speech data to simulate different environments. However, this method simply adds noise to the audio signal without regard to the characteristics of each type of noise. Because the characteristics of noise types are very different, to increase the accuracy of the recognition model, there is a need for a method to model different types of noise.

### BRIEF DESCRIPTION OF THE DRAWINGS

FIG. 1 illustrates the process for noise modeling to improve speech recognition systems.

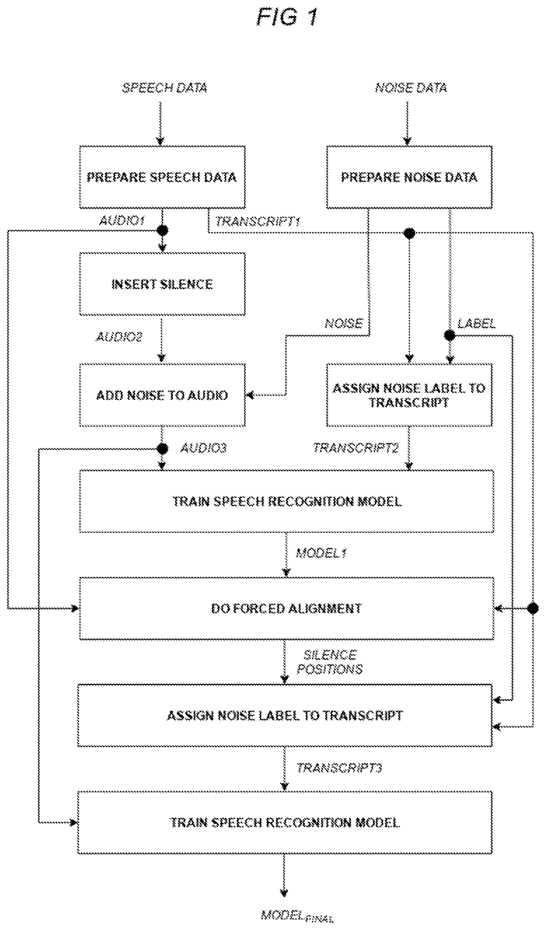

### DETAILED DESCRIPTION

This present invention aims to provide a method to enhance speech recognition quality in different real-life environments.

Specifically, the present invention provides a method including:
Step 1: prepare a speech training data. The speech training data consists of a first set of audio segments containing a speech signal {AUDIO1} and a transcript {TRANSCRIPT1} corresponding to the content of the set of audio segments, thereby providing a training dataset DATA1={AUDIO1, TRANSCRIPT1}. Training data is collected from various sources, including live recording or from the Internet with manual transcript labeling. This dataset is used to train the speech recognition model.
Step 2: prepare a noise data. The noise data consists of a second set of audio segments containing a noise signal {NOISE} along with a label of noise types {LABEL}. The noise signal can vary in different types in the real environments including one or more of office noise, street noise, music noise, wherein these types of noise can be recorded directly or extracted from existing audio tracks.
Step 3: insert additional silences at a beginning and an end of each audio segment. At this step, silences are inserted at the beginning and the end of each audio segment in {AUDIO1} with random length L, with Lₘᵢₙ≤L≤Lₘₐₓ, where 0 second≤Lₘᵢₙ≤1 second, 0.1 second≤Lₘₐₓ≤10 seconds and Lₘₐₓ≥Lₘᵢₙ. After this step, we obtain a new set of audio data with all segments having silences at the beginning and at the end named {AUDIO2}. The insertion of silences at the beginning and the end of each audio segment provides that the beginning and the end of each segment is free of speech signal. This assists with adding a noise signal and a noise label at the beginning and the end of the audio segments in Step 4 and Step 5.
Step 4: add noise to the audio signal. At this step, noise is added to the audio signal by randomly selecting a noise type in the set {NOISE} in Step 2 plus the audio signal {AUDIO2} received in Step 3. This noise addition to ensure that a signal-to-noise ratio SNR satisfies SNRₘᵢₙ≤SNR≤SNRₘₐₓ, where −20 dB≤SNRₘᵢₙ≤20 dB, 0 dB≤SNRₘₐₓ≤40 dB. This step obtains a new set of audio signals, {AUDIO3}. A random addition of different types of noise to the audio signal to simulate the recorded audio signal in different environments to make a training data more diverse, thereby helping the speech recognition model receive more information and hence the model will be more robust with different actual operating conditions. Selection of SNRₘᵢₙ and SNRₘₐₓ in the above ranges to ensure that the audio signal after adding noise will be consistent with data available in practice and in a range that can be recognized.
Step 5: assign noise labels to a speech transcript. This step is implemented by adding to the beginning and the end of a transcript in {TRANSCRIPT1} a label of the corresponding noise in {LABEL} that was added to the audio signal in Step 4. After this process, we obtain a set transcripts {TRANSCRIPT2}, thereby providing a training dataset DATA2={AUDIO3, TRANSCRIPT2}. For example, {TRANSCRIPT1} contains the sentence “hello how are you”. In Step 4, music noise labeled <music> is added then after this step, we get {TRANSCRIPT2} for that sentence will be “<music> hello how are you <music>”.
Step 6: train a speech recognition model. At this step, train the speech recognition model with the training data DATA2. After this step, we obtain a speech recognition model named MODEL1. The training process helps the model to learn the mapping from speech signal to transcripts based on the training data set. The speech recognition model can be a hybrid architecture or an end-to-end architecture;
Step 7: do forced alignment with training data. This step is performed by using the speech recognition model MODEL1 to do forced alignment with the data in DATA1 to find a set of silences {SILENCE} in the audio signal {AUDIO1}. Wherein the transcript is aligned with the audio signal in time. From there we can know the positions of speeches and silences in the audio signal.
Step 8: assign noise labels to the speech transcripts. At this step, we apply noise labels to the speech transcripts by adding at the beginning and the end of each transcript and the positions of silences {SILENCE} in {TRANSCRIPT1} the corresponding noise labels {LABEL} that have been added into the audio signal in Step 4. After this process, we obtain {TRANSCRIPT3}, thereby providing a training dataset DATA3={AUDIO3, TRANSCRIPT3}. For example, {TRANSCRIPT1} contains the sentence “hello how are you” and in Step 7, a silence is detected between the two phrases “hello” and “how are you”. In Step 4, we add music noise labeled as <music> then after this step we obtain {TRANSCRIPT3} for that sentence which will be “<music> hello <music> how are you <music>”.
Step 9: train the speech recognition model. At this step, we train the speech recognition model with the training data DATA3 obtained in Step 8. After this step, we obtain a speech recognition model called MODEL_{FINAL}. The training process helps the model to learn the mapping from speech signal to transcripts based on the training data set. The speech recognition model can be a hybrid architecture or an end-to-end architecture.

### DETAILED DESCRIPTION OF THE INVENTION

The invention is detailed below, specifically, a method of noise modeling to improve speech recognition comprising of steps:
Step 1: prepare a speech training data;
Step 2: prepare a noise data;
Step 3: insert additional silences at a beginning and an end of each audio segment;
Step 4: add noise to the audio signal;
Step 5: assign noise labels to a speech transcript;
Step 6: train a speech recognition model;
Step 7: do forced alignment with training data;
Step 8: assign noise labels to the speech transcripts;
Step 9: train the speech recognition model.

The details of these steps are as follows:
Step 1: prepare a speech training data. The speech training data consists of a first set of audio segments containing a speech signal {AUDIO1} and a transcript {TRANSCRIPT1} corresponding to the content of the set of audio segments, thereby providing a training dataset DATA1={AUDIO1, TRANSCRIPT1}. Training data is collected from various sources, including live recording or from the Internet with manual transcript labeling. This dataset is used to train the speech recognition model.
Step 2: prepare a noise data. The noise data consists of a second set of audio segments containing a noise signal {NOISE} along with a label of noise types {LABEL}. The noise signal can vary in different types in the real environments including one or more of office noise, street noise, music noise, wherein these types of noise can be recorded directly or extracted from existing audio tracks.
Step 3: insert additional silences at a beginning and an end of each audio segment. At this step, silences are inserted at the beginning and the end of each audio segment in {AUDIO1} with random length L, with Lₘᵢₙ≤L≤Lₘₐₓ, where 0 second≤Lₘᵢₙ≤1 second, 0.1 second≤Lₘₐₓ≤10 seconds and Lₘₐₓ≥Lₘᵢₙ. After this step, we obtain a new set of audio data with all segments having silences at the beginning and at the end named {AUDIO2}. The insertion of silences at the beginning and the end of each audio segment provides that the beginning and the end of each segment is free of speech signal. This assists with adding a noise signal and a noise label at the beginning and the end of the audio segments in Step 4 and Step 5.
Step 4: add noise to the audio signal. At this step, noise is added to the audio signal by randomly selecting a noise type in the set {NOISE} in Step 2 plus the audio signal {AUDIO2} received in Step 3. This noise addition to ensure that a signal-to-noise ratio SNR satisfies SNRₘᵢₙ≤SNR≤SNRₘₐₓ, where −20 dB≤SNRₘᵢₙ≤20 dB, 0 dB≤SNRₘₐₓ≤40 dB. This step obtains a new set of audio signals, {AUDIO3}. A random addition of different types of noise to the audio signal to simulate the recorded audio signal in different environments to make a training data more diverse, thereby helping the speech recognition model receive more information and hence the model will be more robust with different actual operating conditions. Selection of SNRₘᵢₙ and SNRₘₐₓ in the above ranges to ensure that the audio signal after adding noise will be consistent with data available in practice and in a range that can be recognized.
Step 5: assign noise labels to a speech transcript. This step is implemented by adding to the beginning and the end of a transcript in {TRANSCRIPT1} a label of the corresponding noise in {LABEL} that was added to the audio signal in Step 4. After this process, we obtain a set transcripts {TRANSCRIPT2}, thereby providing a training dataset DATA2={AUDIO3, TRANSCRIPT2}. For example, {TRANSCRIPT1} contains the sentence “hello how are you”. In Step 4, music noise labeled <music> is added then after this step, we get {TRANSCRIPT2} for that sentence will be “<music> hello how are you <music>”.
Step 6: train a speech recognition model. At this step, train the speech recognition model with the training data DATA2. After this step, we obtain a speech recognition model named MODEL1. The training process helps the model to learn the mapping from speech signal to transcripts based on the training data set. The speech recognition model can be a hybrid architecture or an end-to-end architecture;
Step 7: do forced alignment with training data. This step is performed by using the speech recognition model MODEL1 to do forced alignment with the data in DATA1 to find a set of silences {SILENCE} in the audio signal {AUDIO1}. Wherein the transcript is aligned with the audio signal in time. From there we can know the positions of speeches and silences in the audio signal.
Step 8: assign noise labels to the speech transcripts. At this step, we apply noise labels to the speech transcripts by adding at the beginning and the end of each transcript and the positions of silences {SILENCE} in {TRANSCRIPT1} the corresponding noise labels {LABEL} that have been added into the audio signal in Step 4. After this process, we obtain {TRANSCRIPT3}, thereby providing a training dataset DATA3={AUDIO3, TRANSCRIPT3}. For example, {TRANSCRIPT1} contains the sentence “hello how are you” and in Step 7, a silence is detected between the two phrases “hello” and “how are you”. In Step 4, we add music noise labeled as <music> then after this step we obtain {TRANSCRIPT3} for that sentence which will be “<music> hello <music> how are you <music>”.
Step 9: train the speech recognition model. At this step, we train the speech recognition model with the training data DATA3 obtained in Step 8. After this step, we obtain a speech recognition model called MODEL_{FINAL}. The training process helps the model to learn the mapping from speech signal to transcripts based on the training data set. The speech recognition model can be a hybrid architecture or an end-to-end architecture.

### Examples of Invention

The solution has been applied to build a speech recognition system at Viettel Cyberspace Center. By modeling noise, the recognition model give better recognition results than traditional models, especially in noisy environments.

Two test datasets are used:
The Vivos dataset is simulated in a noisy environment with a signal-to-noise ratio of 0 dB, 3 dB and 5 dB, respectively.
VoiceNote dataset is a dataset recorded in actual meetings.

Three speech recognition models are built:
Model_{Clean}: is a speech recognition model trained with original data without adding noise.
Model_{AddNoise}: is a speech recognition model trained with the original data where noise is added to the speech signal.
Model_{NoiseModeling}: is a speech recognition model trained with the noise modeling method in the present invention.

Table 1 describes the Word Error Rate given by three recognition models with different test sets. We can see that Model_{NoiseModeling} gives significantly lower error than Model_{Clean} and Model_{AddNoise} on all test sets. This has proven the effectiveness of the proposed method.

TABLE 1
Word Error Rate (%) given by recognition models with different test
sets

| | Test Set | | | |
|---|---|---|---|---|
| Speech Recognition | Vivos | | | |
| Model | SNR = 0 dB | SNR = 3 dB | SNR = 5 dB | VoiceNote |
| Model_{Clean} | 57.53 | 38.02 | 28.21 | 32.54 |
| Model_{AddNoise} | 40.42 | 25.03 | 18.83 | 30.40 |
| Model_{NoiseModeling} | 35.51 | 23.10 | 17.67 | 28.95 |

### Effect of Invention

A special advantage related to this present invention is to propose a noise modeling method to improve the quality of the speech recognition model. This method has been applied to several applications such as automatic call center, automatic meeting logging system and significantly improved recognition quality, thereby improving and user experience.

Although the above descriptions contain many specifics, they are not intended to be a limitation of the embodiment of the invention but are intended only to illustrate some preferred execution.

1. A noise modeling method, comprising the steps of:
step 1: prepare a speech training data; the speech training data consists of a first set of audio segments containing a speech signal {AUDIO1} and a transcript {TRANSCRIPT1} corresponding to the content of the set of audio segments, thereby providing a training dataset DATA1={AUDIO1, TRANSCRIPT11};
step 2: prepare a noise data; the noise data consists of a second set of audio segments containing a noise signal {NOISE} along with a label of noise types {LABEL};
step 3: insert additional silences at a beginning and an end of each audio segment, comprising inserting silences at the beginning and the end of each audio segment in {AUDIO1} with random length L, with Lₘᵢₙ≤L≤Lₘₐₓ, where 0 second≤Lₘᵢₙ≤1 second, 0.1 second≤Lₘₐₓ≤10 seconds and Lₘₐₓ≥Lₘᵢₙ; thereby obtaining a new set of audio data with all segments having silences at the beginning and at the end named {AUDIO2}; the insertion of silences at the beginning and the end of each audio segment providing that the beginning and the end of each segment is free of speech signal; to assist with adding a noise signal and a noise label at the beginning and the end of the audio segments in step 4 and step 5;
step 4: add noise to the audio signal; at this step, noise is added to the audio signal by randomly selecting a noise type in the set {NOISE} in step 2 plus the audio signal {AUDIO2} received in step 3, this noise addition to ensure that a signal-to-noise ratio SNR satisfies SNRₘᵢₙ≤SNR≤SNRₘₐₓ, where −20 dB≤SNRₘᵢₙ≤20 dB, 0 dB≤SNRₘₐₓ≤40 dB, this step obtaining a new set of audio signals, {AUDIO3}; a random addition of different types of noise to the audio signal to simulate the recorded audio signal in different environments to make a training data more diverse, thereby helping the speech recognition model receive more information and hence the model will be more robust with different actual operating conditions; selection of SNRₘᵢₙ and SNRₘₐₓ in the above ranges to ensure that the audio signal after adding noise will be consistent with data available in practice and in a range that can be recognized;
step 5: assign noise labels to a speech transcript; this step is implemented by adding to the beginning and the end of a transcript in {TRANSCRIPT1} a label of the corresponding noise in {LABEL} that was added to the audio signal in step 4, after this process we obtain a set transcripts {TRANSCRIPT2}, thereby providing a training dataset DATA2={AUDIO3, TRANSCRIPT2};
step 6: train a speech recognition model; at this step, train the speech recognition model with the training data DATA2; after this step, we obtain a speech recognition model named MODEL1; the training process helps the model to learn the mapping from speech signal to transcripts based on the training data set; the speech recognition model can be a hybrid architecture or an end-to-end architecture;
step 7: do forced alignment with training data; this step is performed by using the speech recognition model MODEL1 to do forced alignment with the data in DATA1 to find a set of silences {SILENCE} in the audio signal {AUDIO1}; wherein the transcript is aligned with the audio signal in time; from there we can know the positions of speeches and silences in the audio signal;
step 8: assign noise labels to the speech transcripts; at this step, we apply noise labels to the speech transcripts by adding at the beginning and the end of each transcript and the positions of silences {SILENCE} in {TRANSCRIPT1} the corresponding noise labels {LABEL} that have been added into the audio signal in step 4; after this process, we obtain {TRANSCRIPT3}, thereby providing a training dataset DATA3={AUDIO3, TRANSCRIPT3};
step 9: train the speech recognition model; at this step, we train the speech recognition model with the training data DATA3 obtained in step 8; after this step, we obtain a speech recognition model called MODEL_{FINAL}; the training process helps the model to learn the mapping from speech signal to transcripts based on the training data set; the speech recognition model can be a hybrid architecture or an end-to-end architecture.

2. The noise modeling method according to claim 1, wherein in step 1, training data is collected from various sources, including live recording or from the Internet with manual transcript labeling and using this dataset to train the speech recognition model.

3. The noise modeling method according to claim 1, wherein in step 2, the noise signal can vary in different types in the real environments including one or more of office noise, street noise, music noise, wherein these types of noise can be recorded directly or extracted from existing audio tracks.
